(19) United States
(12) Patent Application Publication
(10) Pub. No.: US 2026/0032361 A1
(43) Pub. Date: Jan. 29, 2026

(54) IMAGE SENSOR PIXEL WITH MULTIPLE LATERAL OVERFLOW INTEGRATION CAPACITORS

(71) Applicant: Apple Inc., Cupertino, CA (US)

(72) Inventor: Jiaju Ma, Irvine, CA (US)

(21) Appl. No.: 19/270,412

(22) Filed: Jul. 15, 2025

Related U.S. Application Data
(60) Provisional application No. 63/675,147, filed on Jul. 24, 2024.

(51) Int. Cl. H04N 25/771; H04N 25/78

(52) U.S. Cl. CPC H04N 25/771; H04N 25/78

(57) ABSTRACT

Systems, apparatuses, and methods for image sensor pixels with multiple lateral overflow integration capacitors are described. A device including an array of image sensor pixels, including an image sensor pixel described herein, can perform collecting, from a photodiode during a first integration period, a first charge at a floating diffusion node and a first lateral overflow capacitor of a plurality of lateral overflow capacitors of the image sensor pixel; reading, at a first time, the first charge from the floating diffusion node and the first lateral overflow capacitor; resetting, during a first reset period, the first lateral overflow capacitor by coupling the first lateral overflow capacitor to a voltage source; collecting, from the photodiode during a second integration period that at least partly overlaps the first reset period, a second charge at the floating diffusion node and a second lateral overflow capacitor of the plurality of lateral overflow capacitors.

### CROSS-REFERENCE TO RELATED APPLICATIONS

This application claims the benefit under 35 U.S.C. § 119 (e) of U.S. Provisional Patent Application No. 63/675,147, filed Jul. 24, 2024, the contents of which are incorporated herein by reference as if fully disclosed herein.

### TECHNICAL FIELD

The described embodiments relate generally to image sensors and, more particularly, to systems, apparatuses, and methods of operating image sensor pixels with multiple lateral overflow integration capacitors.

### BACKGROUND

Modern consumer electronic devices take many shapes and forms and have numerous uses and functions. Cameras continue to be an important feature of consumer electronics devices. Smartphones, wearables devices, including wrist-worn devices (e.g., watches or fitness tracking devices) and head-mounted devices (e.g., headsets, glasses, or earbuds), and computers (e.g., tablet computers or laptop computers), for example, may use one or more cameras. The imaging capabilities of these consumer electronics devices have steadily increased as individual cameras have improved in quality and devices have started integrating multiple-camera (“multi-camera”) systems and depth sensors. User demand continues for imaging capabilities to capture high quality images in an ever-increasing range of situations, including high dynamic range imaging applications. As such, it may be desirable to continue to improve image sensors, including the design of pixels that make up a pixel array.

### SUMMARY

Described herein are device and methods for image sensor pixels with multiple lateral overflow integration capacitors.

Some aspects of this disclosure are directed to an image sensor pixel. The image sensor pixel includes a photodiode, a floating diffusion node, a first lateral overflow capacitor, a second lateral overflow capacitor, a first reset gate, and a second reset gate. The floating diffusion node is selectively coupled with the photodiode. The first lateral overflow capacitor is selectively coupled with the floating diffusion node. The second lateral overflow capacitor is selectively coupled with the floating diffusion node. The first reset gate is operable to selectively couple the first lateral overflow capacitor to a voltage source during a first reset period to reset the first lateral overflow capacitor. The second reset gate is operable to selectively couple the second lateral overflow capacitor to the voltage source during a second reset period to reset the second lateral overflow capacitor.

Some aspects of this disclosure are directed to an image sensing device. The image sensing device includes an array of image sensor pixels including a photodiode, a floating diffusion node, a plurality of lateral overflow capacitors, and a plurality of reset gates, and control circuitry coupled with the array of image sensor pixels. The floating diffusion node is selectively coupled with the photodiode. The plurality of lateral overflow capacitors is coupled with the floating diffusion node. The plurality of reset gates is selectively coupling the plurality of lateral overflow capacitors to a voltage source, each lateral overflow capacitor associated with at least one of the plurality of reset gates. The control circuitry configured to cause the floating diffusion node and at least one of the plurality of lateral overflow capacitors to collect a charge from the photodiode during at least one integration period. The control circuitry is further configured to cause the at least one of the plurality of lateral overflow capacitors to be coupled with the voltage source during at least one reset period to reset the plurality of lateral overflow capacitors.

Some aspects of this disclosure are directed to a method of controlling an image sensor pixel of an image sensing device. The method includes collecting, from a photodiode during a first integration period, a first charge at a floating diffusion node and a first lateral overflow capacitor of a plurality of lateral overflow capacitors of the image sensor pixel. The method further includes reading, at a first time, the first charge from the floating diffusion node and the first lateral overflow capacitor. The method further includes resetting, during a first reset period, the first lateral overflow capacitor by coupling the first lateral overflow capacitor to a voltage source. The method further includes collecting, from the photodiode during a second integration period that at least partly overlaps the first reset period, a second charge at the floating diffusion node and a second lateral overflow capacitor of the plurality of lateral overflow capacitors.

In addition to the exemplary aspects and embodiments described above, further aspects and embodiments will become apparent by reference to the drawings and by study of the following description.

### BRIEF DESCRIPTION OF THE DRAWINGS

To easily identify the discussion of any particular element or act, the most significant digit or digits in a reference number refer to the figure number in which that element is first introduced.

FIG. 1A shows a rear view of an illustrative example of a device including an image sensor array having pixels with multiple lateral overflow integration capacitors as described herein. FIG. 1B depicts exemplary components of the device of FIG. 1A.

FIG. 2 shows an example image sensing device, according to certain aspects of the present disclosure.

FIG. 3 shows an example image sensor pixel, according to certain aspects of the present disclosure.

FIG. 4 shows an example timing diagram for operation of an image sensor pixel, according to certain aspects of the present disclosure.

FIG. 5 shows another example timing diagram for operation of an image sensor pixel, according to certain aspects of the present disclosure.

FIG. 6 shows another example image sensor pixel, according to certain aspects of the present disclosure.

FIG. 7 shows another example timing diagram for operation of an image sensor pixel, according to certain aspects of the present disclosure.

FIG. 8 shows an example method of controlling an image sensor pixel of an image sensing device, according to certain aspects of the present disclosure.

FIG. 9 shows an example method of controlling an image sensing device, according to certain aspects of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Image sensors that include image sensor pixels with a lateral overflow integration capacitor, also referred to herein as “LOFIC pixels”, have been widely adopted for imaging, in particular, for high dynamic range imaging applications. In an image sensor pixel that includes a lateral overflow integration capacitor (also referred to herein as a “LOFIC capacitor”), charge generated from a photodiode may stored both in a floating diffusion node and a LOFIC capacitor selectively coupled to the floating diffusion node. The LOFIC capacitor provides a charge overflow path, which can increase the amount of charge stored by the image sensor pixel when capturing an image. Accordingly, the LOFIC capacitor may be used to selectively increase the charge storage capabilities of the image sensor pixel, which may reduce the likelihood that the image sensor pixel will saturate when capturing images of scenes having widely varying brightness. Typically, the LOFIC capacitor may be a metal-insulator-metal (MIM) capacitor. MIM capacitors for the image sensor pixel may provide a relatively high capacitance per unit area, for example relative to other capacitor designs, such as a metal oxide semiconductor (MOS) capacitor or polysilicon to polysilicon capacitor. In some examples, MIM capacitors for a LOFIC capacitor may be compatible with a pitch of pixels of a pixel array of equal to or less than about 1 micrometer.

However, conventional LOFIC pixels may introduce image lag artifacts, which degrade image quality, due to dielectric absorption/relaxation effects that occur in the LOFIC capacitor during a reset period for the image sensor pixel. During integration, the polarization of dipoles within a dielectric of a LOFIC capacitor may change, and resetting the image sensor pixel may cause dipoles of the LOFIC capacitor to return toward an initial polarization. If a reset time for resetting the LOFIC capacitor is not sufficiently long, the dipoles may not completely return to their original state. An incomplete reset of dipoles may impact the read out of the image sensor pixel after integration of a subsequent image frame, and may create an image lag artifact in the subsequent image frame.

Described herein are image sensors that include image sensors pixels that utilize multiple charge overflow paths formed by multiple LOFIC capacitors. The use of multiple (e.g., two or more) charge overflow paths can improve the image lag artifacts induced by dielectric absorption and relaxation effects in the high-density MIM capacitors in an image sensor pixel that includes multiple LOFIC capacitors. In a certain mode of operation, the image sensor pixel can alternate between multiple charge overflow paths between the integration phases of different image frames. For example, the image sensor pixel switches between different overflow paths for successive integration phases (e.g., the image sensor pixel uses a first charge overflow path associated with a first LOFIC capacitor during the integration phase of a first image frame and uses a second charge overflow path associated with a second LOFIC capacitor during the integration phase of a succeeding second integration phase). Accordingly, because a given overflow path may not be used in successive integration phases, the LOFIC capacitor associated with that charge overflow path may experience a longer reset time without impacting the overall frame rate of the image sensor. Each overflow path can be separately turned on or off by a dedicated switch (a LOFIC gate), and may also have a dedicated reset switch transistor to independently reset the LOFIC capacitors. The LOFIC capacitors may share a common bias voltage source in some examples, or may have independent bias voltage sources in other examples.

The image sensor pixel includes a floating diffusion node and at least a first LOFIC capacitor and a second LOFIC capacitor, where each of the first and second LOFIC capacitors are selectively coupled to the floating diffusion node. During a first mode of operation of the image sensor, the image sensor may capture a first set of image frames and a second set of image frames, where image frames of the first set alternate with image frames of the second set. In one or more embodiments, the image sensor pixel may selectively collect charge at the first LOFIC capacitor via a first LOFIC gate (e.g., during each of the first set of image frames), and may selectively collect charge at the second LOFIC capacitor via a second LOFIC gate (e.g., during each of a second set of image frames). The image sensor pixel may independently reset each LOFIC capacitor. For example, the first LOFIC capacitor may be reset while the second LOFIC capacitor is used for charge collection during image frames of the first set, and the second LOFIC capacitor may be reset while the first LOFIC capacitor is used for charge collection during image frames of the second set. This may allow for a longer corresponding reset period for each LOFIC capacitor, which are used every other image frame during the first mode of operation. In instances where higher charge collection capabilities are desired, both LOFIC capacitors may be used to collect charge during one or more image frames in a second mode of operation. Additionally, or alternatively, in another mode of operation neither LOFIC capacitor is used to collect charge during one or more image frames.

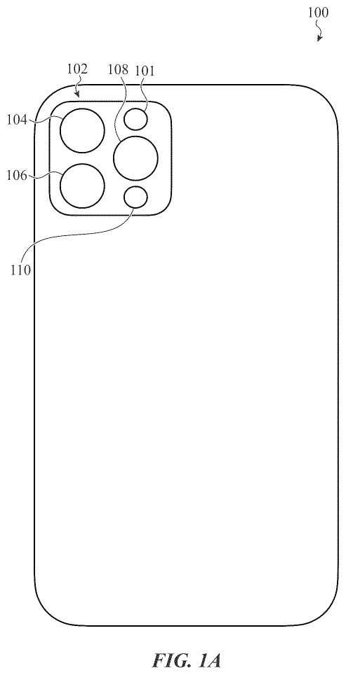

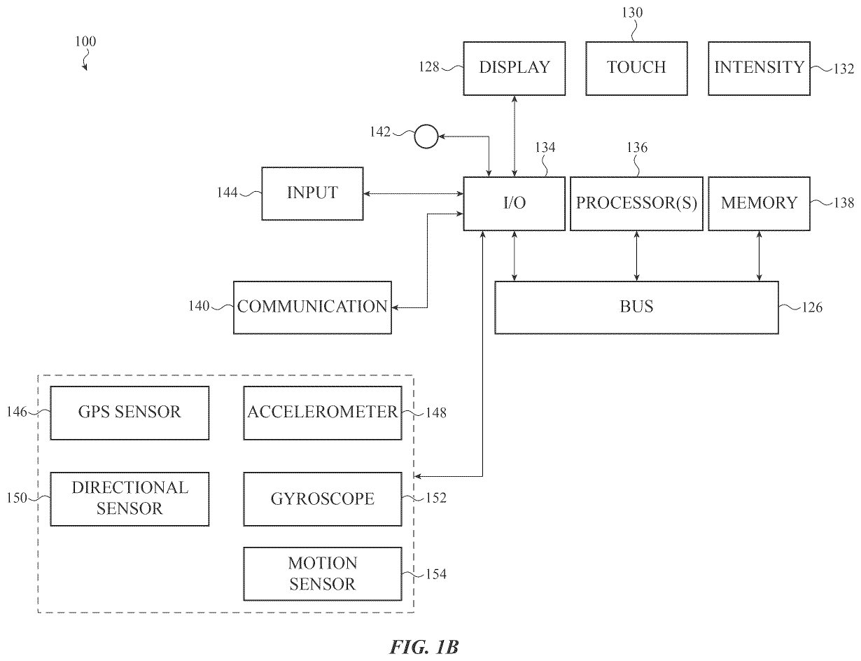

These and other embodiments are discussed below with reference to FIGS. 1A-9. However, those skilled in the art will readily appreciate that the detailed description given herein with respect to these figures is for explanatory purposes only and should not be construed as limiting.

The image sensor pixels with multiple LOFIC capacitors described herein may be incorporated into a camera module, which in turn may be incorporated into an electronic device such as a phone, tablet, computer, or the like. FIG. 1A depicts an example device 100 as described herein. As shown, the device 100 includes a first camera 102 having an image sensor using pixels with multiple LOFIC capacitors.

In some instances, the first camera 102 is part of a multi-camera system. For example, in the variation shown in FIG. 1A, the first camera 102 is part of a multi-camera system having a second camera 104, and a third camera 106. The second camera 104 and/or third camera 106 may also include an image sensor using pixels with multiple LOFIC capacitors as described herein, but need not. It should be appreciated that the device 100 may include a single camera, or a multi-camera system having any number of cameras (with any relative positioning) as may be desired. Additionally, while shown as placed on the rear of a device 100, it should be appreciated that a camera having an image sensor using pixels with multiple LOFIC capacitors may be additionally or alternatively placed on the front (e.g., a front side having a display) or any other side of the device as desired.

In some instances, the device 100 may include a flash module 108. The flash module 108 may provide illumination to some or all of the fields of view of the cameras of the device 100 (e.g., the fields of view of the first camera 102, the second camera 104, and/or the third camera 106). This may assist with image capture operations in low light settings. Additionally, or alternatively, the device 100 may further include a depth sensor 110 that may calculate depth information for a portion of the environment around the device 100. Specifically, the depth sensor 110 may calculate depth information within a field of coverage (i.e., the widest lateral extent to which the depth sensor is capable of providing depth information). The field of coverage of the depth sensor 110 may at least partially overlap the field of view of one or more of the cameras (e.g., the fields of view of the first camera 102, second camera 104, and/or third camera 106). The depth sensor 110 may be any suitable system that is capable of calculating the distance between the depth sensor 110 and various points in the environment around the device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In instances where a depth sensor utilizes infrared illumination, this infrared illumination may be utilized in a range of ambient conditions without being perceived by a user.

In some embodiments, the device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. In other embodiments, the device 100 is a head-mounted device, such as an extended reality (XR) device, which may include augmented reality (AR) or virtual reality (VR) devices. Exemplary embodiments of head-mounted devices include, without limitation, the Vision Pro® device from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of the device 100. In some embodiments, device 100 has a bus 126 that operatively couples an I/O section 134 with one or more computer processors 136 and memory 138. The I/O section 134 can be connected to display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. The device 100 can include input mechanisms 142 and/or 144. Input mechanism 142 is, optionally, a rotatable input device or a depressible and rotatable input device, for example. Input mechanism 142 is, optionally, a button, in some examples. The device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the device 100 or a portion thereof.

Memory 138 of the device 100 can include one or more non-transitory computer-readable storage mediums, for storing computer-executable instructions, which, when executed by one or more computer processors 136, for example, can cause the computer processors to perform the techniques that are described here (such as actuating the mechanical iris assemblies described herein). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate capturing of images as described herein. Device 100 is not limited to the components and configuration of FIG. 1B, but can include other or additional components in multiple configurations.

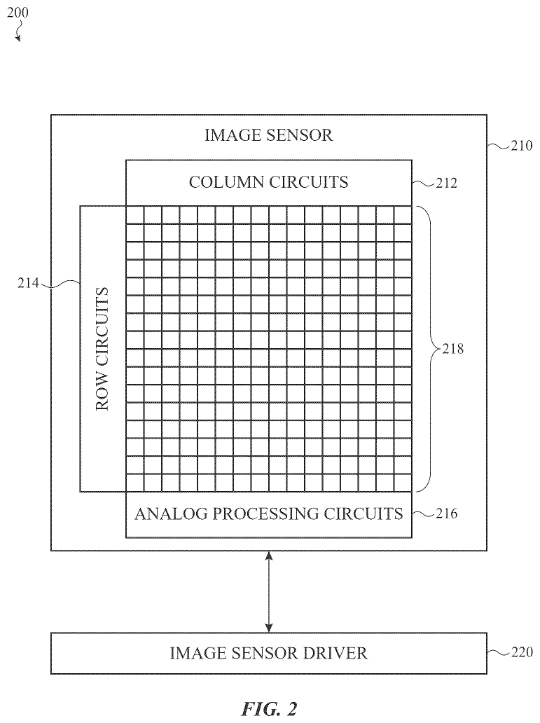

FIG. 2 shows an example image sensing device 200, according to certain aspects of the present disclosure. In one or more embodiments, image sensing device 200 supports one or more aspects of image sensor pixel with multiple LOFIC capacitors, as further described herein. The image sensing device 200 includes an image sensor 210 and image sensor driver 220 coupled with the image sensor 210.

The image sensor 210 includes a pixel array 218 that includes an array of image sensor pixels. Each of at least a subset of pixels of the image sensor pixels of pixel array 218 may be configured as an image sensor pixel with multiple LOFIC capacitors, as further described herein. The image sensor 210 further includes column circuits 212 and row circuits 214 used to selectively access and readout each image sensor pixel in the pixel array 218 during integration, readout, and reset operations during a given image frame. Analog processing circuits 216 include one or more amplifiers and analog-to-digital converters (ADCs). The one or more amplifiers are used to read out charge collected from photodiodes of pixels of the pixel array 218. The ADCs convert the analog signal associated with the collected charge to a digital signal indicating a value of the charge. Analog processing circuits 216 may include additional circuits such as gain control circuits (e.g., an automatic gain control (AGC) circuit).

Image sensor driver 220 includes circuits to supply signals to control various operations of the image sensor 210. Image sensor driver 220 can drive column circuits 212 and row circuits 214 during integration, readout, and reset operations of the image sensor 210. Additionally, image sensor driver 220 can provide signals to column circuits 212 and row circuits 214 to selectively reset capacitors of the pixels of the pixel array 218. In some embodiments, the image sensor driver 220 can cause the image sensing device 200 to operate according to one of a number of different operating modes. For example, the image sensing device 200 may be operated according to different frame rates. During operation of the image sensing device 200, the image sensor 210 may be operated to capture a series of image frames. Each image frame has a corresponding i) reset phase during which charge stored in each image sensor pixel of the pixel array 218 is reset to a predetermined level, ii) an integration phase during which image sensor pixels of the pixel array 218 generate and store photocurrent based on incoming light, iii) a readout phase during which the charge stored by the image sensor pixels of the pixel array 218 is measured.

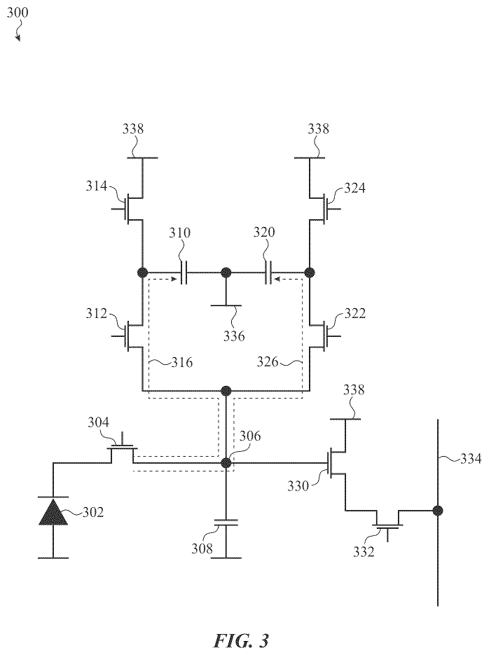

FIG. 3 shows an example image sensor pixel 300, according to certain aspects of the present disclosure. In one or more embodiments, image sensor pixel 300 supports one or more aspects of image sensor pixel with multiple LOFIC capacitors, as further described herein. In some examples, the image sensor pixel 300 may be an example of a pixel of the pixel array 218. The use of LOFIC capacitors for image sensor pixel 300 may allow for reduced image artifacts at higher frame rates during high dynamic range imaging.

Image sensor pixel 300 includes a photodiode 302 selectively coupled with a floating diffusion (FD) node 306 via a transfer gate 304. When exposed to light, the photodiode 302 absorbs photons to generate a charge via the photoelectric effect. The photodiode 302 may generate this charge during an integration phase of an image frame, and the FD node 306 acts to receive and temporarily store this charge until the charge is read out as part of readout phase of the image frame. Accordingly, charge may be accumulated at the photodiode 302 and at the FD node 306 via the transfer gate 304.

During operation of the image sensor pixels described herein, each gate or transistor may be in either an on state (in which current flows through the transistor) or an off state (in which current does not flow through the transistor) depending on a bias across the gate/transistor and a control signal applied to the gate/transistor. For example, when a gate or transistor is described herein as being “closed”, the gate/transistor receives a control signal with a corresponding voltage level that is selected such that the gate/transistor remains in an off state during operation of the image sensor pixel. Alternatively, when a gate or transistor is described herein as being “open”, the gate/transistor receives a control signal with a corresponding voltage that is selected such that the gate/transistor may enter an on state. In some instances, an open gate may be “fully” open. In these instances, the control signal may be set to a voltage that is selected such that the gate remains in an on state during operation of the image sensor pixel. Accordingly, a fully open gate may act as a short circuit and allow for current to freely flow through the gate. In other instances, an open gate may be “partially” open. In these instances, the control signal may be set to an intermediate voltage that is selected such that the gate only enters an on state when the potential across the gate reaches a certain level.

Specifically, a partially open gate may be used to allow for collection of overflow current. For example, the transfer gate 304 may be partially open during an integration phase of an image frame, which may allow the FD node 306 to collect overflow current when the charge level in the photodiode exceeds a threshold level. In these instances, the transfer gate 304 may receive a control signal with a voltage that is selected such that the transfer gate 304 enters an on state when the charge level in the photodiode exceeds the threshold level. Although the transfer gate 304 is considered open (e.g., partially open) during this integration period, the transfer gate 304 may remain in an off state if the charge level in the photodiode does not exceed the threshold level.

The FD node 306 has a capacitance to surrounding structures within the image sensor pixel 300 (illustrated schematically in FIG. 3 as capacitor 308) that controls how much charge the FD node 306 may hold. Accordingly, the photodiode 302 and the FD node 306 each have a limited capacity to store charge. It may be desirable, such as when an image sensor performs high dynamic range image operations, for the image sensor pixel 300 to provide storage for more charge than the photodiode 302 and the FD node 306, by themselves, can hold. Accordingly, the image sensor pixel 300 includes a first LOFIC capacitor 310 having a first terminal selectively coupled to the FD node 306 via a first LOFIC gate 312. Charge generated by the photodiode 302 may be further (e.g., in addition to charge stored by the FD node 306) received and stored by the first LOFIC capacitor 310 while both the transfer gate 304 and the first LOFIC gate 312 are open. In this way, the first LOFIC gate 312 and the first LOFIC capacitor 310 are operable to define a first charge overflow path 316.

In some instances, each of the transfer gate 304 and the first LOFIC gate 312 may be partially open during an integration period of an image frame. In these instances, the FD node 306 may receive overflow current via the transfer gate 304 when the charge level photodiode 302 reaches a first threshold level, and the first LOFIC capacitor 310 may receive overflow current from the FD node 306 via the first LOFIC gate 312 when the charge level in the FD node 306 reaches a second threshold level. In other instances, the transfer gate 304 may be partially open and the first LOFIC gate 312 may be fully open during an integration period of an image frame. In these instances, overflow current received via the transfer gate 304 is collectively stored in the FD node 306 and the first LOFIC capacitor 310.

The first terminal of the first LOFIC capacitor 310 is further selectively coupled to a voltage source 338 via a first reset gate 314. A second terminal of the first LOFIC capacitor 310 may be coupled with a bias voltage source 336. In some embodiments, the bias voltage source may have a value in the range from ground to VDD. In some embodiments, the first LOFIC capacitor 310 may be a MIM capacitor, as further described herein.

In addition to the first LOFIC capacitor 310, it may be desirable for the image sensor pixel 300 to further include a second LOFIC capacitor 320 to provide storage for additional charge generated by the photodiode 302. Accordingly, the image sensor pixel 300 may further include a second LOFIC capacitor 320 having a first terminal selectively coupled to the FD node 306 via a second LOFIC gate 322. Charge generated by the photodiode 302 may be further (e.g., in addition to charge stored by the FD node 306) received and stored by the second LOFIC capacitor 320 while both the transfer gate 304 and the second LOFIC gate 322 are open. In this way, the second LOFIC gate 322 and the second LOFIC capacitor 320 are operable to define a second charge overflow path 326.

In some instances, each of the transfer gate 304 and the second LOFIC gate 322 may be partially open during an integration period of an image frame. In these instances, the FD node 306 may receive overflow current via the transfer gate 304 when the charge level photodiode 302 reaches a first threshold level, and the second LOFIC capacitor 320 may receive overflow current from the FD node 306 via the second LOFIC gate 322 when the charge level in the FD node 306 reaches a second threshold level. In other instances, the transfer gate 304 may be partially open and the second LOFIC gate 322 may be fully open during an integration period of an image frame. In these instances, overflow current received via the transfer gate 304 is collectively stored in the FD node 306 and the second LOFIC capacitor 320.

The first terminal of the second LOFIC capacitor 320 is further selectively coupled to a voltage source 338 via a second reset gate 324. A second terminal of the second LOFIC capacitor 320 may be coupled with the bias voltage source 336. In some embodiments, the bias voltage source may have a value in the range from ground (e.g., GND) to VDD. In some embodiments, the second LOFIC capacitor 320 may be a MIM capacitor, as further described herein.

In some embodiments, as shown for the image sensor pixel 300, the first LOFIC capacitor 310 and the second LOFIC capacitor 320 share a common bias voltage source 336. In other embodiments, the image sensor pixel 300 can use a first bias voltage source (not shown) for the first LOFIC capacitor 310 and a different second bias voltage source (not shown) for the second LOFIC capacitor 320.

The first LOFIC gate 312 and the second LOFIC gate 322 are separately controllable, which may control the flow of charge between the FD node 306 and the first LOFIC gate 312 (e.g., along the first charge overflow path 316), and between the FD node 306 and the second LOFIC gate 322 (e.g., along the second charge overflow path 326), respectively. For example, the image sensor pixel 300 may be controlled, for example in response to control signaling from a processor (e.g., image sensor driver 220, processor 136), to control which charge overflow paths are active during the integration phase of a given image frame. During certain modes of operation, the first LOFIC gate 312 and the second LOFIC gate 322 may be open (e.g., partially open or fully open) at a same time during the integration phase of an image frame to allow charge to accumulate from the photodiode 302 in parallel.

In other modes of operation, the first LOFIC gate 312 and the second LOFIC gate 322 may be open at different times (e.g., alternately) to allow charge to accumulate from the photodiode 302 alternately during different image frames. For example, during the integration phases of some image frames, the second LOFIC gate 322 may be closed while the first LOFIC gate 312 is open (e.g., partially open or fully open). During these integration phases, charge from the FD node 306 may be accumulated at the first LOFIC capacitor 310 along the first charge overflow path 316 but is not accumulated at the second LOFIC capacitor 320. During the integration phases of other image frames, the first LOFIC gate 312 may be closed while the second LOFIC gate 322 is open (e.g., partially open or fully open). During these times, charge from the FD node 306 may be accumulated at the second LOFIC capacitor 320 along the second charge overflow path 326 but is not accumulated at the first LOFIC capacitor 310. In still other modes of operation, the first LOFIC gate 312 and the second LOFIC gate 322 may both be closed during the integration phase of an image frame, such that the image sensor pixel 300 does not utilize either the first charge overflow path 316 or the second charge overflow path 326.

The image sensor pixel 300 further includes a readout circuit, which may include a source follower transistor 330 and a readout select gate 332. A gate of the source follower transistor 330 may be coupled with the FD node 306. The source follower transistor 330 and the readout select gate 332 selectively couple a select line 334 to a voltage source 338. When the readout select gate 332 is open (e.g., to select the image sensor pixel 300 for readout), the source follower transistor 330 allows current to flow between the select line 334 and the voltage source 338, where the amount of current is based on the amount of charge accumulated and stored by the image sensor pixel 300 in at least the FD node 306. Accordingly, the readout circuit may be operated to measure the amount of charge stored by at least the FD node 306. In some instances, the transfer gate 304 may be fully opened during a portion of the readout, such that the readout circuit may also measure the charge that was stored in the photodiode 302. Similarly, the first LOFIC gate 312 and/or the second LOFIC gate 322 may be fully open during a portion the readout, such that the readout circuit may also measure charge stored by the first LOFIC capacitor 310 and/or the second LOFIC capacitor 320.

The image sensor pixel 300 may be operated to perform a single sampling operation or a multiple sampling operation (e.g., a double sampling operation) during a readout phase of an image frame. For example, during a single sampling operation the readout circuit may make a single measurement of the charge stored by image sensor pixel 300. In some of these variations, the transfer gate 304, as well as the corresponding LOFIC gate of any charge overflow path that was active during the integration period, may be fully opened, such that the readout circuitry may measure the collective charge stored in the photodiode 302, the FD node 306, and any LOFIC capacitors that were active during the integration period.

During a multiple sampling operation, the readout circuit may make multiple separate measurements of charge stored by the image sensor pixel 300. For example, the transfer gate 304 may be in an off state (e.g., the transfer gate 304 may be closed) during a first measurement, such that the readout circuit may measure charge stored in the FD node 306 (and one or more of the LOFIC capacitors, depending on whether one or both of the charge overflow paths were active during the integration period). In these instances, the first measurement may not include the charge stored in the photodiode 302. The transfer gate 304 may be fully opened after the first measurement, and a second measurement may be performed that may reflect the charge that was stored in the photodiode 302. It should be appreciated that, depending on the sampling operation, the image sensor pixel may include additional measurements during a readout phase and/or may reset the FD node 306 between some of the individual measurements of the sampling operation.

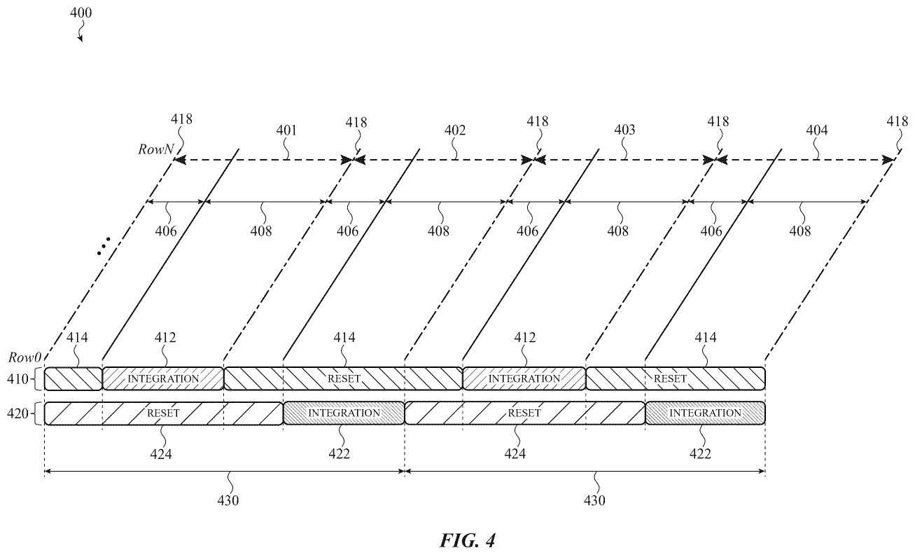

FIG. 4 shows an example timing diagram 400, according to certain aspects of the present disclosure. In one or more embodiments, timing diagram 400 supports one or more aspects of image sensor pixel with multiple LOFIC capacitors during a first mode of operation, as further described herein. For example, timing diagram 400 illustrates the timing of integration, readout, and reset phases of image frames captured by an image sensor pixel, where the image sensor pixel alternates between utilizing a first LOFIC capacitor (and an associated first charge overflow path) and a second LOFIC capacitor (and an associated second charge overflow path). In one or more embodiments, one or more aspects of device 100 (e.g., an image sensor of a camera system) or image sensing device 200 may operate according to timing diagram 400. In some embodiments, an image sensor pixel operating according to timing diagram 400 may be image sensor pixel 300.

Timing diagram 400 illustrates the functional operation of an image sensor pixel using at least two LOFIC capacitors. For the purpose of discussion, the operations of timing diagram 400 are described with respect to the image sensor pixel 300 of FIG. 3. The timing diagram 400 illustrates operation of the image sensor pixel 300 during a series of image frames that are captured during the first mode of operation. The series of images as depicted in FIG. 4 includes four successive image frames: a first image frame 401, a second image frame 402, a third image frame 403, and a fourth image frame 404. It should be appreciated that the series of image frames may include any suitable number of image frames, and the image sensing device 200 may continue to capture image frames until the image sensing device 200 ceases operations of changes to a different mode of operation. Each image frame includes three phases: a reset phase 406, an integration phase 408, and a readout phase 418.

The series of image frames includes a first set of image frames (e.g., including first image frame 401 and third image frame 403) and a second set of image frames (e.g., including second image frame 402 and fourth image frame 404). The series of image frames may be divided into a number of repeating frame periods 430, each of which includes an image frame from the first set and an image frame from the second set. Accordingly, image frames of the first set of image frames alternate with image frames of the second set of image frames. Each image frame of the first set of image frames includes a corresponding integration phase 408 during which the first LOFIC capacitor 310 is coupled to the FD node 306 to collect charge along the first charge overflow path 316. Conversely, each image from of the second set of image frames includes a corresponding integration phase 408 during which the second LOFIC capacitor 320 is coupled to the FD node 306 to collect charge along the second charge overflow path 326. Accordingly, each frame period 430 may include an image frame that is captured using the first LOFIC capacitor 310 and an image frame that is captured using the second LOFIC capacitor 320.

During collection of the series of image frames, the first LOFIC capacitor 310 may be operated according to a first LOFIC operation 410 and the second LOFIC capacitor 320 may be operated according to a second LOFIC operation 420, as illustrated in FIG. 4. Specifically, the first LOFIC operation 410 may include a sequence of integration periods 412 and reset periods 414 for the first LOFIC capacitor 310. Similarly, the second LOFIC operation 420 may include a sequence of integration periods 422 and reset periods 424 for the second LOFIC capacitor 320. Within a single frame period 430, the first LOFIC operation 410 will include an integration period 412 for the first LOFIC capacitor 310 and an integration period 422 for the second LOFIC capacitor 320.

As shown, the timing of the periods of the first LOFIC operation 410 and the periods of the second LOFIC operation 420 may be different within a single frame period 430. For example, the first image frame 401 and the second image frame 402 collectively form a frame period 430 in FIG. 4, During the reset phase 406 of the first image frame 401, the first LOFIC operation 410 includes a portion of a reset period 414 for the first LOFIC capacitor 310 and the second LOFIC operation 420 includes a first portion of a reset period 424 for the second LOFIC capacitor 320. During the integration phase 408 of the first image frame 401, the first LOFIC operation 410 includes an integration period 412 for the first LOFIC capacitor 310 and the second LOFIC operation 420 includes a second portion of the reset period 424 for the second LOFIC capacitor 320. During the reset phase 406 of the second image frame 402, the first LOFIC operation 410 includes a first portion of a subsequent reset period 414 for the first LOFIC capacitor 310 and the second LOFIC operation 420 includes a third portion of the reset period 424 for the second LOFIC capacitor 320. During the integration phase 408 of the second image frame 402, the first LOFIC operation 410 includes a second portion of the subsequent reset period 414 for the first LOFIC capacitor 310 and the second LOFIC operation 420 includes an integration period 422 for the second LOFIC capacitor 320.

In one or more embodiments, during the integration period 412 of the first LOFIC operation 410 charge may be received from the photodiode 302 and stored at the first LOFIC capacitor 310 while transfer gate 304 and the first LOFIC gate 312 are open. The transfer gate 304 and the first LOFIC gate 312 being open allows the photodiode 302 to be coupled to the FD node 306 (e.g., when the transfer gate 304 is in an on state) and allows the FD node 306 to be coupled to the first LOFIC capacitor 310 (e.g., when the first LOFIC gate 312 is in an on state). During the integration period 412, the first reset gate 314 is closed (such that the first LOFIC capacitor 310 is electrically isolated from the voltage source 338). Accordingly, during the integration phase 408 of image frames of the first set of image frames (e.g., the first image frame 401 and the third image frame 403), charge may be collected by the first LOFIC capacitor 310 along the first charge overflow path 316. Additionally, in image frames where the second LOFIC capacitor 320 is in a reset period during the integration phase of that image frame, the second LOFIC gate 322 is closed such that the second LOFIC capacitor 320 is electrically isolated from the FD node 306. Accordingly, during the integration phase 408 of the first set of image frames, at least a portion of the charge generated at the photodiode 302 may flow to the first LOFIC capacitor 310 via the first charge overflow path 316, but charge is not collected along the second charge overflow path 326.

Similarly, in one or more embodiments, during the integration period 422 of the second LOFIC operation 420 charge may be received from the photodiode 302 and stored at the second LOFIC capacitor 320 while transfer gate 304 and the second LOFIC gate 322 are open. The transfer gate 304 and the second LOFIC gate 322 being open allows the photodiode 302 to be coupled to the FD node 306 (e.g., when the transfer gate 304 is in an on state) and allows the FD node 306 to be coupled to the second LOFIC capacitor 320 (e.g., when the second LOFIC gate 322 is in an on state). During the integration period 412, the second reset gate 324 is closed (such that the second LOFIC capacitor 320 is electrically isolated from the voltage source 338). Accordingly, during the integration phase 408 of image frames of the second set of image frames (e.g., the second image frame 402 and the fourth image frame 404), charge may be collected by the second LOFIC capacitor 320 along the second charge overflow path 326. Additionally, in image frames where the first LOFIC capacitor 310 is in a reset period during the integration phase of that image frame, the first LOFIC gate 312 is closed such that the first LOFIC capacitor 310 is electrically isolated from the FD node 306. Accordingly, during the integration phase 408 of the second set of image frames, at least a portion of the charge generated at the photodiode 302 may flow to the second LOFIC capacitor 320 via the second charge overflow path 326, but charge is not collected along the first charge overflow path 316.

In one or more embodiments, during the reset period 414 of the first LOFIC operation 410, the first LOFIC capacitor 310 may be coupled to the voltage source 338 with the first reset gate 314 being open (e.g., fully open). The reset period 414 for the first LOFIC capacitor 310 may span multiple image frames and may also span multiple phases within a given image frame. For example, a first portion of the reset period 414 for the first LOFIC capacitor 310 may occur during (e.g., overlap) the reset phase 406 of the second image frame 402, a second portion of the reset period 414 may occur during the integration phase 408 of the second image frame 402, and a third portion of the reset period 414 may occur during the reset phase 406 of the third image frame 403.

The integration period 422 for the second LOFIC capacitor 320 may at least partially overlap the reset period 414 for the first LOFIC capacitor 310. For example, the second portion of the reset period 414 of the first LOFIC capacitor 310 may overlap the integration period 422 of the second LOFIC capacitor 320 during the integration phase 408 of the second image frame 402. The first LOFIC gate 312 change between opened and closed states during different portions of the reset period 414. For example, during the second portion of the reset period 414 (e.g., that overlaps with the integration phase 408 of the second image frame 402), the first LOFIC gate 312 may be closed to electrically isolate the first LOFIC capacitor 310 from the FD node 306. During the first portion and/or the third portion of the reset period 414, the first LOFIC gate 312 may be opened (e.g., fully opened) to couple the FD node 306 to the voltage source 338 via the first reset gate 314 and the first LOFIC gate 312. This may facilitate resetting the FD node 306 during the reset phase of a given image frame.

Similarly, in one or more embodiments, during the reset period of the second LOFIC operation 420, the second LOFIC capacitor 320 may be coupled to the voltage source 338 with the second reset gate 324 being open (e.g., fully open). The reset period 424 for the second LOFIC capacitor 320 may span multiple image frames and may also span multiple phases within a given image frame. For example, a first portion of the reset period 424 for the second LOFIC capacitor 320 may occur during the reset phase 406 of the first image frame 401, a second portion of the reset period 424 may occur during the integration phase 408 of the first image frame 401, and a third portion of the reset period 424 may occur during the reset phase 406 of the second image frame 402. Similarly, a subsequent reset period 424 for the second LOFIC capacitor 320 may overlap each of the reset phase 406 of the third image frame 403, the integration phase 408 of the third image frame 403, and the reset phase 406 of the fourth image frame 404.

The integration period 412 for the first LOFIC capacitor 310 may at least partially overlap the reset period 424 for the second LOFIC capacitor 320. For example, the second portion of the reset period 424 of the second LOFIC capacitor 320 may overlap the integration period 412 of the first LOFIC capacitor 310 during the integration phase 408 of the first image frame 401. The second LOFIC gate 322 change between opened and closed states during different portions of the reset period 424. For example, during the second portion of the reset period 424 (e.g., that overlaps with the integration phase 408 of the first image frame 401), the second LOFIC gate 322 may be closed to electrically isolate the second LOFIC capacitor 320 from the FD node 306. During the first portion and/or the third portion of the reset period 424, the second LOFIC gate 322 may be opened (e.g., fully opened) to couple the FD node 306 to the voltage source 338 via the second reset gate 324 and the second LOFIC gate 322. This may facilitate resetting the FD node 306 during the reset phase of a given image frame.

During the readout phases of each of the series of image frames, the image sensor pixel 300 may be configured to read out the charge that is collected in the FD node 306, as well as in the photodiode 302 and any of the LOFIC capacitors that were used to collect charge during the integration phase of that image frame. In one or more embodiments, at the end of an integration period 412 of the first LOFIC capacitor 310, charged stored by the image sensor pixel 300 may be read out in a first sampling operation. As part of the first sampling operation, the charge stored in the photodiode 302, the FD node 306, and the first LOFIC capacitor 310 may be read out via one or more individual measurements. This may occur during the readout phases 418 of the first set of image frames (e.g., during the readout phases 418 of the first image frame 401 and the third image frame 403). During each individual measurement, the readout select gate 332 is opened, thereby allowing the source follower transistor 330 to drive the select line 334 according to a charge stored by the FD node 306 (and any additional components coupled to the FD node 306). In instances where the readout phase 418 of an image frame overlaps with a reset period 424 of the second LOFIC capacitor 320, the second LOFIC gate 322 is closed during that readout phase 418.

In one or more embodiments, at the end of an integration period 422 of the second LOFIC capacitor 320, charged stored by the image sensor pixel 300 may be read out in a first sampling operation. As part of the first sampling operation the charge stored in the photodiode 302, the FD node 306, and the second LOFIC capacitor 320 may be read out via one or more individual measurements. This may occur during the readout phases 418 of the second set of image frames (e.g., during the readout phases 418 of the second image frame 402 and the fourth image frame 404). During each individual measurement, the readout select gate 332 is open, allowing the source follower transistor 330 to drive the select line 334 according to a charge stored by the FD node 306 (and any additional components coupled to the FD node 306). In instances where the readout phase 418 of an image frame overlaps with a reset period 414 of the second LOFIC capacitor 320, the second LOFIC gate 322 is closed during that readout phase 418.

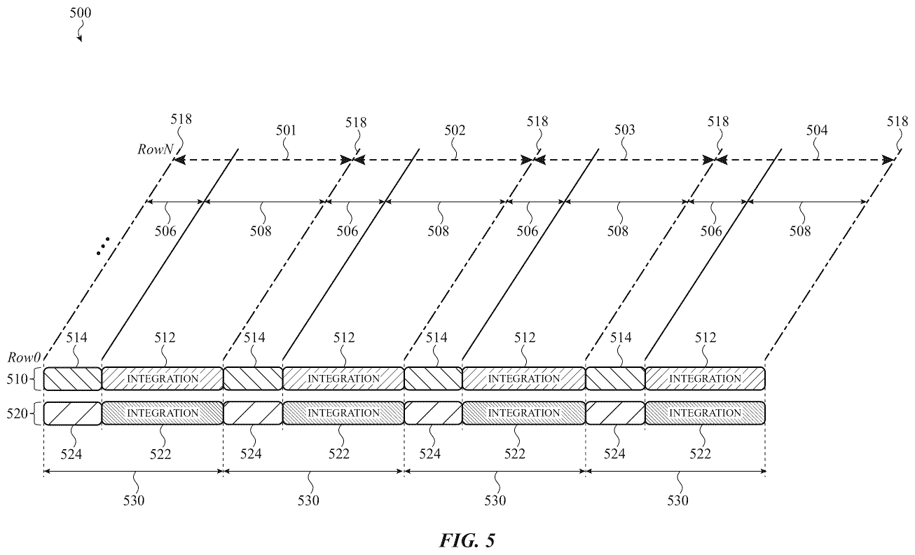

During other modes of operation, multiple LOFIC capacitors of an image sensor pixel may be simultaneously used to store charge. FIG. 5 shows an example timing diagram 500, according to certain aspects of the present disclosure. In one or more embodiments, timing diagram 500 supports one or more aspects of image sensor pixel with multiple LOFIC capacitors during a second mode of operation, as further described herein. For example, timing diagram 500 illustrates the timing of integration, readout, and reset phases of an image sensor pixel utilizing a first LOFIC capacitor and a second LOFIC capacitor in parallel. In this way, photocurrent generated by a photodiode may be stored in multiple charge overflow pathways during the same integration phase. In one or more embodiments, one or more aspects of device 100 (e.g., an image sensor of a camera system) or image sensing device 200 may operate according to timing diagram 500. In some embodiments, an image sensor pixel operating according to timing diagram 500 may be image sensor pixel 300. For clarity, features not specifically described with reference to timing diagram 500 may have the corresponding description as for timing diagram 400.

Timing diagram 500 illustrates the functional operation of an image sensor pixel using at least two LOFIC capacitors. For the purpose of discussion, the operations of timing diagram 400 are described with respect to the image sensor pixel 300 of FIG. 3. The timing diagram 500 illustrates operation of the image sensor pixel during a series of image frames that are captured during the second mode of operation. The series of image frames shown in FIG. 4 includes four successive image frames: a first image frame 501, a second image frame 502, a third image frame 503, and a fourth image frame 504. It should be appreciated that the series of image frames may include any suitable number of image frames, and the image sensing device 200 may continue to capture image frames until the image sensing device 200 ceases operations of changes to a different mode of operation. Each image frame includes three phases: a reset phase 506, an integration phase 508, and a readout phase 518.

The series of image frames may be divided into a number of repeating frame periods 530. In the variation shown in FIG. 5, each frame period 530 includes a single image frame, though it should be appreciated that in other instances each frame period 530 may include one or more additional image frames that utilize a different selection of charge overflow paths. Each frame period 530 includes an image frame that has a corresponding integration phase 508, during which the first LOFIC capacitor 310 and the second LOFIC capacitor 320 are simultaneously coupled to the FD node 306 to collect charge along both the first charge overflow path 316 and the second charge overflow path 326.

During collection of the series of image frames, the first LOFIC capacitor 310 may be operated according to a first LOFIC operation 510 and the second LOFIC capacitor 320 may be operated according to a second LOFIC operation 520, as illustrated in FIG. 5. Specifically, the first LOFIC operation 510 may include a sequence of integration periods 512 and reset periods 514 for the first LOFIC capacitor 310. Similarly, the second LOFIC operation 520 may include a sequence of integration periods 522 and reset periods 524 for the second LOFIC capacitor 320. Within a single frame period 530, the first LOFIC operation 510 will include at least a reset period 514 and an integration period 512 for the first LOFIC capacitor 310, and the second LOFIC operation 520 will include at least a reset period 524 and an integration period 522 for the second LOFIC capacitor 320.

For at least one image frame of each frame period 530, the image frame includes an integration phase 508 that includes both the integration period 512 of the first LOFIC capacitor 310 and the integration period 522 of the second LOFIC capacitor 320. The integration phase 508 thus uses both the first LOFIC capacitor 310 and the second LOFIC capacitor 320 in parallel, and thus charge is collected along the first charge overflow path 316 and the second charge overflow path 326 during a common time duration. When the integration period 512 of the first LOFIC capacitor 310 and the integration period 522 of the second LOFIC capacitor 320 overlap during the integration phase 508, the transfer gate 304 is open to allow the FD node 306 to be coupled to and receive charge from the photodiode 302, the first LOFIC gate 312 is open to allow the first LOFIC capacitor 310 to be coupled to and receive charge from the FD node 306, and the second LOFIC gate 322 is open to allow the second LOFIC capacitor 320 to be coupled to and receive charge from the FD node 306. Additionally, both the first reset gate 314 and the second reset gate 324 are closed (such that the first LOFIC capacitor 310 and the second LOFIC capacitor 320 are electrically isolated from the voltage source 338). Overall, during the integration phase 508 of an image frame (e.g., any of the first image frame 501, the second image frame 502, the third image frame 503, or the fourth image frame 504), at least a portion of the charge generated at the photodiode 302 may flow to the first LOFIC capacitor 310 via the first charge overflow path 316 and at least a portion of the charge generated at the photodiode 302 may flow to the second LOFIC capacitor 320 via the second charge overflow path 326.

The image frame may further include a reset phase 506 that includes both a reset period 514 for the first LOFIC capacitor 310 and a reset period 524 for the second LOFIC capacitor 320. Accordingly, during the reset phase 506 both the first LOFIC capacitor 310 and the second LOFIC capacitor 320 are connected to a first voltage source (e.g., VDD) to reset the LOFIC capacitors. The reset phase 506 may be characterized by the first LOFIC capacitor 310 being coupled to the first voltage source with the first reset gate 314 being open (as part of the reset period 514 for the first LOFIC capacitor 310) and the second LOFIC capacitor 320 being coupled to the first voltage source with the second reset gate 324 being open (as part of the reset period 524 for the second LOFIC capacitor 320). One or both of the first LOFIC gate 312 or the second LOFIC gate 322 may be open during the reset phase 506 to couple the FD node 306, which may reset the FD node 306. Additionally, the transfer gate 304 may be closed during the reset phase 506 so that FD node 306 is not collected photocurrent from the photodiode 302.

A readout phase 518 follows the integration phase 508, and allow for charge that was collectively stored in the FD node 306, the first LOFIC capacitor 310, and the second LOFIC capacitor 320 to be read out. Specifically, during the readout phase 518 a sampling operation may allow for the measurement of charge stored by photodiode 302, the first LOFIC capacitor 310, and the second LOFIC capacitor 320 via one or more individual measurements.

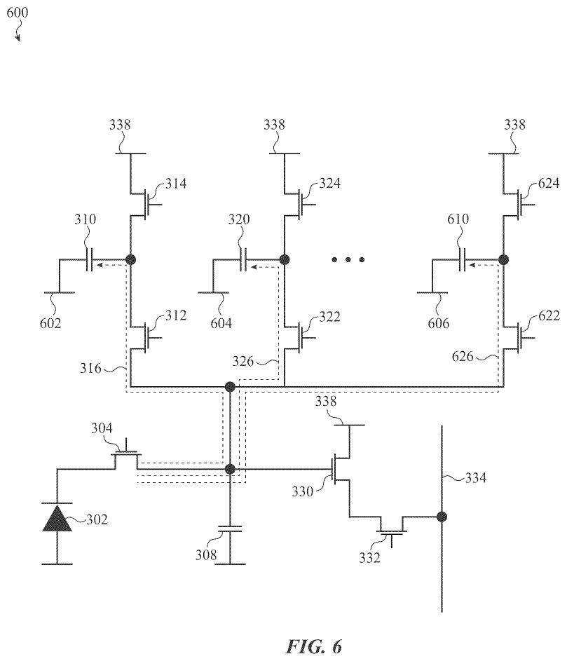

While the image sensor pixel 300 of FIG. 3 is shown as having two LOFIC capacitors that define two charge overflow paths, it should be appreciated that the image sensors described herein may include image sensor pixels having three or more charge overflow paths, each associated with a corresponding LOFIC capacitor. For example, FIG. 6 shows an example image sensor pixel 600, according to certain aspects of the present disclosure. The image sensor pixel 600 is configured and labeled the same as the image sensor pixel 300 of FIG. 3, except that the image sensor pixel 600 includes additional LOFIC capacitors beyond the first LOFIC capacitor 310 and the second LOFIC capacitor 320. Specifically, the image sensor pixel 600 includes a number N of LOFIC capacitors, where N is greater than two. Only the first LOFIC capacitor 310, the second LOFIC capacitor 320, and an Nth LOFIC capacitor 610 are shown in FIG. 6.

The Nth LOFIC capacitor 610 has a first terminal selectively coupled to the FD node 306 via an Nth LOFIC gate 612, and may form an Nth charge overflow path 626. Charge may be further (e.g., in addition to charge at the FD node 306) accumulated at the Nth LOFIC capacitor 610 while both the transfer gate 304 and the Nth LOFIC gate 612 are open. The first terminal of the Nth LOFIC capacitor 610 is further selectively coupled to the voltage source 338 via an Nth reset gate 624. A second terminal of the Nth LOFIC capacitor 610 may be coupled with an Nth bias voltage source 606. In some embodiments, the bias voltage source may have a value in the range from ground to VDD. In some embodiments, the Nth LOFIC capacitor 610 may be a MIM capacitor, as further described herein.

In some embodiments, the image sensor pixel 600 uses different bias voltages for different LOFIC capacitors. For example, the image sensor pixel 600 can use a first bias voltage source 602 for the first LOFIC capacitor 310, a second bias voltage source 604 for the second LOFIC capacitor 320, and a Nth bias voltage source 606 for the Nth LOFIC capacitor 610.

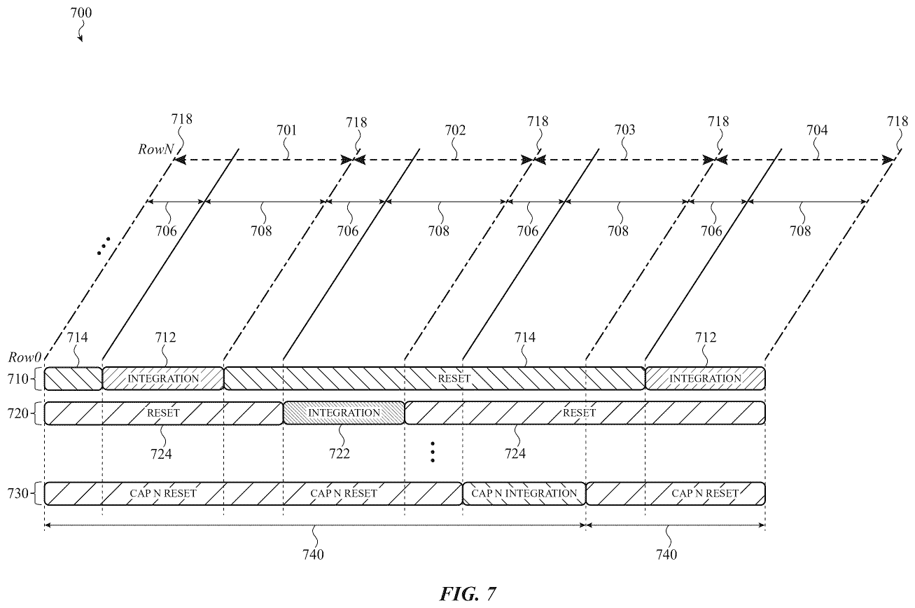

The image sensor pixel 600 may be operated in a number of different modes to capture image frames. Since the image sensor pixel 600 has at least three different charge overflow paths, there may be different selections of charge overflow paths that can be used during the integration phase of a given image frame. For example, during the integration phases of certain image frames, none of the charge overflow paths are used to collect charge (e.g., each of the LOFIC capacitors are in respective reset periods and are electrically isolated from the FD node 306), such that charge is collected only in the FD node 306 during these image frames. During the integration phase of other image frames, a single charge overflow path may be used to collect charge (such as described herein with respect to FIG. 7). In still other image frames, multiple charge overflow paths (e.g., a subset of the overflow paths or all of the overflow paths) may be used to collect charge during the integration phase of a given image frame.

FIG. 7 shows an example timing diagram 700, according to certain aspects of the present disclosure. In one or more embodiments, timing diagram 700 supports one or more aspects of image sensor pixel with three or more LOFIC capacitors, as further described herein. For example, timing diagram 700 illustrates the timing of integration, reset, and readout phases of image frames, during which an image sensor pixel sequentially alternates between the charge overflow paths defined by N LOFIC capacitors. In one or more embodiments, one or more aspects of device 100 (e.g., an image sensor of a camera system) or image sensing device 200 may operate according to timing diagram 700. For the purpose of discussion, the operations of timing diagram 400 are described with respect to the image sensor pixel 600 of FIG. 6. For clarity, features not specifically described with reference to timing diagram 700 may have the corresponding description as for timing diagram 400 and/or timing diagram 500.

The timing diagram 700 illustrates operation of the image sensor pixel 600 during four image frames: first image frame 701, second image frame 702, third image frame 703, and fourth image frame 704. The series of image frames includes N different sets of images, each associated with a different LOFIC capacitor. For example, in an instance where Nis three, the series of image frames includes a first set of image frames (e.g., including first image frame 701 and fourth image frame 704), a second set of image frames (e.g., including second image frame 702), and a third set of image frames (e.g., including third image frame 703). The series of image frames may be divided into a number of repeating frame periods 740, each of which includes a corresponding image frame from each of the N sets of images. Each image frame includes three phases: a reset phase 706, an integration phase 708, and a readout phase 718. As shown for the timing diagram 700, a single frame period 740 may repeat. That is, frames of the first set of frames (e.g., including first image frame 701 and fourth image frame 704), rotate with frames of the second set of frames (e.g., including second image frame 702), and so on, up to rotating with frames of the Nth set of frames (e.g., including third image frame 703).

Each of the N LOFIC capacitors is associated with a corresponding LOFIC operation (e.g., a first LOFIC operation 710 for the first LOFIC capacitor 310, a second LOFIC operation 720 for the second LOFIC capacitor 320, and an Nth LOFIC operation 730 for the Nth LOFIC capacitor). Each LOFIC operation includes an integration period and a reset period, such as described above with respect to the timing diagram 400 of FIG. 4. Each image frame of the frame period 740 includes a corresponding integration phase 708 that is associated with an integration period of a single LOFIC capacitor and a reset period for the remaining LOFIC capacitors. For example, during the integration phase 708 of the first image frame 701, the first LOFIC capacitor 310 may be in an integration period 712 (e.g., with the first LOFIC gate 312 open and the first reset gate 314 closed), the second LOFIC capacitor 320 may be in a reset period 724 (e.g., with the second LOFIC gate 322 closed and the second reset gate 324 open), and the Nth LOFIC capacitor 610 may be in a reset period 734 (e.g., with the Nth LOFIC gate 622 closed and the Nth reset gate 624 open). During the integration phase 708 of the second image frame 702, the second LOFIC capacitor 320 may be in an integration period 722 (e.g., with the second LOFIC gate 322 open and the second reset gate 324 closed), the first LOFIC capacitor 310 may be in a reset period 714 (e.g., with the first LOFIC gate 312 closed and the first reset gate 314 open), and the Nth LOFIC capacitor 610 may be in a reset period 734. During the integration phase 708 of the third image frame 703 (which may represent the Nth image frame of the frame period 740) the Nth LOFIC capacitor 610 may be in an integration period 732 (e.g., with the Nth LOFIC gate 622 open and the Nth reset gate 624 closed), the first LOFIC capacitor 310 may be in a reset period 714, and the second LOFIC capacitor 320 may be in a reset period 724.

During the reset phases of these image frames, all of the LOFIC capacitors may be in respective reset periods. It should be appreciated that some or all of the LOFIC gates may be open to during the reset phase to connect the FD node 306 to the voltage source 338 and thereby reset the FD node 306.

By alternating the use of the first LOFIC capacitor, the second LOFIC capacitor, and so on, up to an Nth LOFIC capacitor, a periodicity of operation of pixels of an image sensor may remain the same, while further increasing the length of the reset period for each respective LOFIC capacitor (e.g., further extending the duration relative to timing diagram 400 or timing diagram 500 for a two LOFIC image sensor pixel). In some examples, a duration of a frame may thereby be shortened, resulting in a higher frame rate, while allowing an adequate reset duration for each LOFIC of a pixel utilizing the LOFIC.

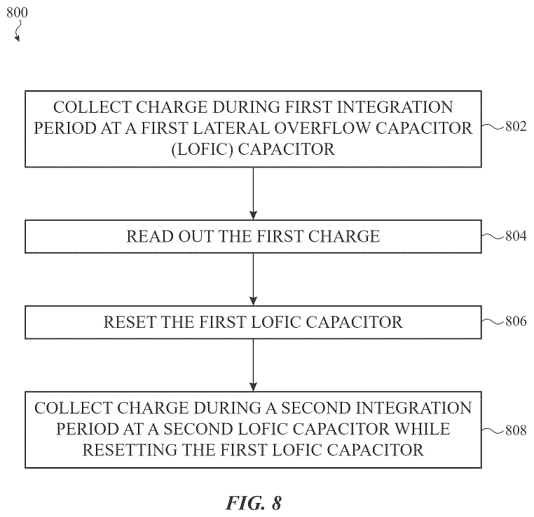

FIG. 8 shows an example method 800 of controlling an image sensor pixel of an image sensing device, according to certain aspects of the present disclosure. In some cases, one or more aspects of the method 800 may be performed by the device 100, or one or more components thereof, for example a processor (e.g., component processor 136), or a combination of these. In some embodiments, the processor (e.g., component processor 136) may include or be coupled to memory (e.g., memory 138) that may store instructions that, when executed by the processor, cause the processor to perform the operations of the method 800. As the processor performs the operations of the method 800, the processor may also cause the device 100, or one or more components thereof, to perform or discontinue various operations. In some cases, one or more aspects of the method 800 may be performed by or using the image sensing device 200, image sensor pixel 300, image sensor pixel 600, or one or more components thereof. In some cases, the method 800 may be performed consistent with one or more of timing diagram 400, timing diagram 500, or timing diagram 700.

At 802, the method 800 includes collecting charge during a first integration period at a first LOFIC capacitor. In some embodiments, the method 800 includes collecting, from a photodiode during a first integration period, a first charge at a floating diffusion node and a first lateral overflow capacitor of a plurality of LOFIC capacitors of the image sensor pixel.

At 804, the method 800 includes reading out the first charge. In some embodiments, the method 800 includes reading, at a first time, the first charge from the floating diffusion node and the first LOFIC capacitor.

At 806, the method 800 includes resetting the first LOFIC capacitor. In some embodiments, the method 800 includes resetting, during a first reset period, the first LOFIC capacitor by coupling the first LOFIC capacitor to a voltage source.

At 808, the method 800 includes collecting charge during a second integration period at a second LOFIC while resetting the first LOFIC. In some embodiments, the method 800 includes collecting, from the photodiode during a second integration period that at least partly overlaps the first reset period, a second charge at the floating diffusion node and a second LOFIC capacitor of the plurality of LOFIC capacitors.

In one or more embodiments, the method further includes reading, at a second time during the first reset period, the second charge from the floating diffusion node and the second lateral overflow capacitor.

In one or more embodiments, the method further includes resetting, during a second reset period, the second LOFIC capacitor by coupling the second lateral overflow capacitor to the voltage source, where the second reset period includes at least the first integration period.

In one or more embodiments, the method further includes detecting a light condition that does not meet a brightness threshold value; and disabling, at least partly in response to the detecting, one or more of the first LOFIC capacitor or the second LOFIC capacitor for charge collection.

In one or more embodiments, the method further includes detecting a light condition that meets or exceeds a brightness threshold value; and enabling, at least partly in response to the detecting, one or more of the first LOFIC capacitor or the second LOFIC capacitor for charge collection. In other words, the image sensor may change its mode of operation depending on brightness levels present in the scene being imaged. For example, if light levels are sufficiently low, the image sensor may operate in a mode of operation where no charge overflow paths of a given image sensor pixel are utilized in the integration phase of image frames captured by the image sensor. Above a certain light level, the image sensor may operate in a different mode of operation where successive image frames alternate between multiple charge overflow paths during an integration phase for a given image sensor pixel (such as described herein with respect to FIGS. 4 and 7). At even high light levels, the image sensor may operate in a mode of operation where multiple charge overflow paths of an image sensor pixel are used during an integration phase of a given image frame (such as described herein with respect to FIG. 5). The image sensor may dynamically switch between different modes of operation during as needed.

In some embodiments, the first reset period alternates with a second reset period, and the first integration period alternates with the second integration period.

The method 800 may be variously embodied, extended, or adapted, as described in the following paragraphs and elsewhere in this description.

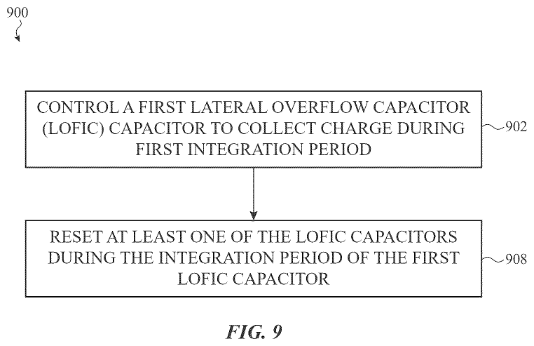

FIG. 9 shows an example method 900 of controlling an image sensing device, according to certain aspects of the present disclosure. In some cases, one or more aspects of the method 900 may be performed by the device 100, or one or more components thereof, for example a processor (e.g., component processor 136), or a combination of these. In some embodiments, the processor (e.g., component processor 136) may include or be coupled to memory (e.g., memory 138) that may store instructions that, when executed by the processor, cause the processor to perform the operations of the method 900. As the processor performs the operations of the method 900, the processor may also cause the device 100, or one or more components thereof, to perform or discontinue various operations. In some cases, one or more aspects of the method 900 may be performed by or using the image sensing device 200, image sensor pixel 300, image sensor pixel 600, or one or more components thereof. In some cases, the method 900 may be performed consistent with one or more of timing diagram 400, timing diagram 500, or timing diagram 700.

At 902, the method 900 includes controlling a first LOFIC to collect charge during first integration period. In some embodiments, the method 900 includes causing, by control circuitry coupled with an array of image sensor pixels, a floating diffusion node and at least one of a plurality of LOFIC capacitors to collect a charge from a photodiode during at least one integration period.

At 904, the method 900 includes resetting at least one of the LOFIC capacitors during the integration period of the first LOFIC. In some embodiments, the method 900 includes causing, by the control circuitry, the at least one of the plurality of LOFIC capacitors to be coupled with a voltage source during at least one reset period to reset the plurality of LOFIC capacitors, the at least one reset period overlapping the at least one integration period, and a plurality of reset gates selectively coupling the plurality of LOFIC capacitors to the voltage source, each LOFIC capacitor associated with at least one of the plurality of reset gates.

In one or more embodiments, the method further includes causing, by the control circuitry, a first LOFIC capacitor of the plurality of LOFIC capacitors to be coupled with the voltage source during a first reset period to reset the first LOFIC capacitor; and causing, by the control circuitry, a second LOFIC capacitor of the plurality of LOFIC capacitors to be coupled with the voltage source during a second reset period to reset the second LOFIC capacitor, the second reset period different from the first reset period.

In one or more embodiments, the method further includes causing, by the control circuitry, a first LOFIC capacitor of the plurality of LOFIC capacitors and a second LOFIC capacitor of the plurality of LOFIC capacitors to be coupled with the voltage source during a same reset period of the at least one reset period to reset the first LOFIC capacitor and the second LOFIC capacitor.

In one or more embodiments, the method further includes causing, by the control circuitry, the floating diffusion node and a first LOFIC capacitor of the plurality of LOFIC capacitors to collect a first charge from the photodiode during a first integration period of the at least one integration period; and causing, by the control circuitry, the floating diffusion node and a second LOFIC capacitor of the plurality of LOFIC capacitors to collect a second charge from the photodiode during a second integration period of the at least one integration period, the second integration period different from the first integration period.

In one or more embodiments, the method further includes causing, by the control circuitry, the floating diffusion node, a first LOFIC capacitor of the plurality of LOFIC capacitors, and a second LOFIC capacitor of the plurality of LOFIC capacitors to collect the charge from the photodiode during a same integration period of the at least one integration period.

In one or more embodiments, the method further includes causing, by the control circuitry, a select gate to couple a source follower transistor to a select line of the image sensing device to read the charge stored on the floating diffusion node and the at least one of the plurality of LOFIC capacitors, where each image sensor pixel of the array further includes the source follower transistor and the select gate.

In one or more embodiments, the method further includes causing, by the control circuitry, charge to be collected to the plurality of LOFIC capacitors for a first light condition; and disabling, by the control circuitry, collection of charge to the plurality of LOFIC capacitors for a second light condition that is a relatively lower light condition than the first light condition.

The method 900 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 800 or 900. In the context of the method 800 or 900, this non-transitory computer-readable media may be, for example, a memory (e.g., a memory 138, as described herein) of a device 100.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

1. An image sensor pixel, comprising:
a photodiode;
a floating diffusion node selectively coupled with the photodiode;
a first lateral overflow capacitor selectively coupled with the floating diffusion node;
a second lateral overflow capacitor selectively coupled with the floating diffusion node;
a first reset gate operable to selectively couple the first lateral overflow capacitor to a voltage source during a first reset period to reset the first lateral overflow capacitor; and
a second reset gate operable to selectively couple the second lateral overflow capacitor to the voltage source during a second reset period to reset the second lateral overflow capacitor.

2. The image sensor pixel of claim 1, further comprising:
a readout circuit coupled with the floating diffusion node.

3. The image sensor pixel of claim 1, further comprising:
a third lateral overflow capacitor selectively coupled with the floating diffusion node.

4. The image sensor pixel of claim 1, wherein:
a first terminal of the first lateral overflow capacitor is selectively coupled with the floating diffusion node and a second terminal of the first lateral overflow capacitor is coupled with a bias voltage source; and
a first terminal of the second lateral overflow capacitor is selectively coupled with the floating diffusion node and a second terminal of the second lateral overflow capacitor is coupled with the bias voltage source.

5. The image sensor pixel of claim 1, wherein:
a first terminal of the first lateral overflow capacitor is selectively coupled with the floating diffusion node and a second terminal of the first lateral overflow capacitor is coupled with a first bias voltage source; and
a first terminal of the second lateral overflow capacitor is selectively coupled with the floating diffusion node and a second terminal of the second lateral overflow capacitor is coupled with a second bias voltage source different from the first bias voltage source.

6. The image sensor pixel of claim 1, wherein the first lateral overflow capacitor and the second lateral overflow capacitor are each a metal-insulator-metal (MIM) capacitor.

7. An image sensing device, comprising:
an array of image sensor pixels, a first pixel of the array comprising:
a photodiode;
a floating diffusion node selectively coupled with the photodiode;
a plurality of lateral overflow capacitors selectively coupled with the floating diffusion node; and
a plurality of reset gates, wherein each reset gate of the plurality of reset gates selectively couples a corresponding lateral overflow capacitor of the plurality of lateral overflow capacitors to a voltage source; and
control circuitry configured to:
control the floating diffusion node and at least one of the plurality of lateral overflow capacitors to collect a charge from the photodiode during at least one integration period; and
control the at least one of the plurality of lateral overflow capacitors to be coupled with the voltage source during at least one reset period to reset the plurality of lateral overflow capacitors.

8. The image sensing device of claim 7, wherein the control circuitry configured to reset the plurality of lateral overflow capacitors comprises the control circuitry configured to:
cause a first lateral overflow capacitor of the plurality of lateral overflow capacitors to be coupled with the voltage source during a first reset period to reset the first lateral overflow capacitor; and
cause a second lateral overflow capacitor of the plurality of lateral overflow capacitors to be coupled with the voltage source during a second reset period to reset the second lateral overflow capacitor, the second reset period different from the first reset period.

9. The image sensing device of claim 7, further comprising:
cause a first lateral overflow capacitor of the plurality of lateral overflow capacitors and a second lateral overflow capacitor of the plurality of lateral overflow capacitors to be coupled with the voltage source during a same reset period of the at least one reset period to reset the first lateral overflow capacitor and the second lateral overflow capacitor.

10. The image sensing device of claim 7, wherein controlling the floating diffusion node and the at least one of the plurality of lateral overflow capacitors to collect the charge from the photodiode during the at least one integration period comprises:
controlling the floating diffusion node and a first lateral overflow capacitor of the plurality of lateral overflow capacitors to collect a first charge from the photodiode during a first integration period of the at least one integration period; and
controlling the floating diffusion node and a second lateral overflow capacitor of the plurality of lateral overflow capacitors to collect a second charge from the photodiode during a second integration period of the at least one integration period, the second integration period different from the first integration period.

11. The image sensing device of claim 7, wherein controlling the floating diffusion node and the at least one of the plurality of lateral overflow capacitors to collect the charge from the photodiode during the at least one integration period comprises:
controlling the floating diffusion node, a first lateral overflow capacitor of the plurality of lateral overflow capacitors, and a second lateral overflow capacitor of the plurality of lateral overflow capacitors to collect the charge from the photodiode during a same integration period of the at least one integration period.

12. The image sensing device of claim 7, wherein:
the first pixel further comprises a source follower transistor and a select gate; and
the control circuitry is further configured to cause the select gate to couple the source follower transistor to a select line of the image sensing device to read the charge stored on the floating diffusion node and the at least one of the plurality of lateral overflow capacitors.

13. The image sensing device of claim 7, wherein the control circuitry if configured to:
cause charge collection to the plurality of lateral overflow capacitors for a first light condition; and
disable the charge collection to the plurality of lateral overflow capacitors for a second light condition that is a relatively lower light condition than the first light condition.

14. A method of controlling an image sensor pixel of an image sensing device, comprising:
collecting, from a photodiode during a first integration period, a first charge at a floating diffusion node and a first lateral overflow capacitor of a plurality of lateral overflow capacitors of the image sensor pixel;
reading, at a first time, the first charge from the floating diffusion node and the first lateral overflow capacitor;
resetting, during a first reset period, the first lateral overflow capacitor by coupling the first lateral overflow capacitor to a voltage source; and
collecting, from the photodiode during a second integration period that at least partly overlaps the first reset period, a second charge at the floating diffusion node and a second lateral overflow capacitor of the plurality of lateral overflow capacitors.

15. The method of claim 14, further comprising:
reading, at a second time during the first reset period, the second charge from the floating diffusion node and the second lateral overflow capacitor.

16. The method of claim 14, further comprising:
resetting, during a second reset period, the second lateral overflow capacitor by coupling the second lateral overflow capacitor to the voltage source, wherein the second reset period includes at least the first integration period.

17. The method of claim 16, further comprising:
detecting, prior to a third integration period that at least partly overlaps the second reset period, a light condition;
disabling, in response to the light condition not meeting a threshold brightness value, the first lateral overflow capacitor during the third integration period; and
collecting, from the photodiode during the third integration period, a third charge from the floating diffusion node while the first lateral overflow capacitor is disabled.

18. The method of claim 14, further comprising:
detecting a light condition before the first integration period, wherein the first charge is collected during the first integration period in response to the light condition not meeting a threshold brightness value.

19. The method of claim 14, wherein:
a first set of frames include the first integration period, a first portion of the first reset period, and a first portion of the second reset period; and
a second set of frames include the second integration period, a second portion of the first reset period, and a second portion of the second reset period.

20. The method of claim 19, wherein frames of the first set of frames alternate with frames of the second set of frames.
